(19) United States
(12) Patent Application Publication
(10) Pub. No.: US 2004/0231167 A1
(43) Pub. Date: Nov. 25, 2004

(54) Fingertip suture-cutting apparatus

(76) Inventor: John R. Miklos, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 10/440,917

(22) Filed: May 19, 2003

(51) Int. Cl. B26D 1/00; B26D 3/00; B26B 29/00; B26B 27/00

(52) U.S. Cl. 30/298; 83/13; 30/294

(57) ABSTRACT

A suture cutting apparatus for cutting a suture during a surgical procedure. The suture cutting apparatus is arranged for receipt on a fingertip. The apparatus comprises a hollow, generally cylindrically shaped housing, the housing has a first or distal end and a second or proximal end. A razor blade is supported on the distal end of the housing. The first or distal end of the housing is closed by a hemispherically shaped enclosure. The hemispherically shaped enclosure has a flange on a distal portion thereof to support the blade. The flange has a V-shaped notch disposed thereon, and the blade is arranged in the notch.

### BACKGROUND OF THE INVENTION

1. Field of the Invention

The present invention relates to surgical devices and more particularly to suture cutter arrangements to be worn by surgeons during medical procedures.

2. Prior Art

Most surgical procedures require the suturing of tissue during or subsequent to that procedure. Cutting of such sutures is typically done with a pair of scissors which is passed from the scrub nurse to the surgical assistant or to the surgeon directly. In cutting the suture, often those scissors must be steadied with a second hand of the surgeon, or await the correct angle to approach the suture by those scissors. This is often hazardous as it may require reaching across the patient for those scissors and such scissors may also inadvertently cut neighboring tissue.

The possibility of a more manipulable and safer alternative to scissors is thus very desirable.

Thread or suture cutting arrangements have been proposed over the past few years. Such suture cutter or thread cutting arrangements, while helpful sometimes are not very practical in actual use. Examples of some of the cutting arrangements are shown for instance in U.S. Pat. No. 3,879,846 to Allen, Jr. disclosing a surgical suture cutter and remover. This arrangement, however, appears to require even more careful manipulation than a pair of scissors. U.S. Pat. No. 3,990,144 to Schwartz presents a suture cutter and removal means which might be difficult to manipulate in a surgical setting, and might be readily lost during a surgical procedure. U.S. Pat. No. 5,015,252 to Jones shows a surgical forceps with suture cutters which is much like a pair of tweezers. This will again require manipulation much like a pair of scissors. U.S. Pat. No. 5,016,353 to Iten shows a suture cutter with an adjustable blade thereon. U.S. Pat. No. 5,250,052 to St. Cyr shows a surgical removal tool which appears somewhat cumbersome and may in actuality be more difficult to utilize than a pair of scissors. U.S. Des. Pat. No. 386,819 to Doyle shows a flexible finger-mounted razor. This is an improvement over the earlier art yet it may still be less than desirable because of the arrangement of its razor appendage. U.S. Pat. No. 6,010,170 to Fligg et al discloses a finger mounted cake decorating device for moving a decoration to a cake once that decoration has been manufactured. Such an arrangement, however, would not be readily adaptable for use as a suture cutter because bent fingers would be certainly in the way of the approach to any tissue.

It is an object of the present invention to overcome the disadvantages of the prior art suture cutting arrangements.

It is yet a further object of the present invention to improve the efficiency and safety of a surgical procedure by the elimination of unnecessary movement or reaching of the surgeon, the surgical assistant or the scrub nurse.

It is still yet a further object of the present invention to permit the cutting of sutures without compromising or slowing down the suture cutting process.

### BRIEF SUMMARY OF THE INVENTION

The present invention comprises a fingertip mountable suture cutter apparatus with a housing of generally cylindrical shape. The suture cutter apparatus has a distalmost end of a fingertip-enclosing hemispherical shape and an opened fingertip receiving proximalmost end. The housing has a curvilinear lowermost body portion and an uppermost opened portion. The uppermost portion of the housing of the suture cutter apparatus is defined by a plurality of slightly flexible, arcuately disposed ribs. The arcuate ribs, a first and second on each lateral side of the housing, are spaced longitudinally apart and their tips are spaced transversely apart. The spaced apart configuration of these flexible ribs permits adaptation of the suture cutter apparatus to any of the fingers of a left or right hand.

A transversely mounted flange is unitarily molded on the distalmost end of the hemispherical tip portion of the housing. The flange has a pair of side edges which taper laterally and proximally towards the hemispherical housing. A V-shaped notch is arranged across the forward edge of the flange, the notch being defined by guide edges meeting at an apex comprising an angle of about 120 degrees. A razor blade is arranged within the V-shaped notch in the flange at the distalmost end of the hemispherical housing. The blade is recessed from the distalmost edge of the flange to permit a suture to be guided towards that blade by the sloped guide edges of the V-shaped notch as the user's finger is advanced towards and against a suture. The transverse flange and its recessed blade therewith, generally lie in longitudinal alignment with the longitudinal axis of the user's finger when that finger is arranged within the suture cutting apparatus. This longitudinal alignment between the blade and the user's finger permits a natural aiming and thrusting motion towards a suture so as to make the cutting thereof a normal part of the finger motion.

A further embodiment of the present invention comprises a suture cutter apparatus generally similar to the aforementioned embodiment, wherein a generally peripheral flange extends distally off of the hemispherical tip of the housing of the suture apparatus. An X-shaped recess is disposed across the peripheral protrusion so as to define an X-shaped suture receiving channel therewithin. A razor blade is arranged diagonally across the intersection of the X-shaped receiving channel. The X-shaped receiving channel permits a suture to be captured therein by longitudinal advancement of the suture cutter apparatus on a surgeon's finger tip. Such an arrangement of suture receiving channels minimizes the twisting manipulation required of the suture cutting apparatus as it is intended to be used.

A yet further embodiment of the present invention comprises a peripheral protrusion arranged on the distalmost portion of the hemispherical tip of the suture cutter apparatus. A single suture receiving channel is arranged transversely or laterally across the distalmost protrusion to define a receiving channel. A razor is arranged across that suture receiving channel and perpendicular thereto recessed so as to receive a suture yet enabling so as to cut that suture once it has been received thereacross.

The invention thus comprises a suture cutting apparatus for cutting a suture during a surgical procedure, the suture cutting apparatus arranged for receipt on a fingertip, the apparatus comprising: a hollow, generally cylindrically shaped housing, the housing having a first or distal end and a second or proximal end; and a razor blade supported on the distal end of the housing. The first or distal end of the housing is closed by a hemispherically shaped enclosure. The hemispherically shaped enclosure has a flange on a distal portion thereof to support the blade. The flange has a V-shaped notch disposed thereon, the blade being arranged in the notch. The notch has a pair of side edges defining the notch, the notch having an angle of about 120 degrees. The blade is recessed in the notch. The proximal end of the housing includes a pair of flexible, laterally spaced apart ribs for circumferential engagement of a finger in the apparatus. The proximal end of the housing may include a pair of flexible, longitudinally spaced apart ribs for circumferential engagement of a finger in the apparatus. The proximal end of the housing may include a pair of flexible, laterally and longitudinally spaced apart ribs for circumferential engagement of a finger in the apparatus.

A peripheral flange protrusion is arranged on the hemispherically shaped enclosure in a further embodiment of the present invention. An X-shaped recess may be arranged across the peripheral protrusion. A razor blade is arranged diagonally across the intersection of the channels. The blade is preferably recessed with respect to the channels. The proximal end of the housing may include a pair of flexible, laterally spaced apart ribs for circumferential engagement of a finger in the apparatus. The housing has a longitudinal axis, and the blade is preferably in general alignment with the longitudinal axis of the housing.

A linear channel may in a further embodiment be arranged across the peripheral protrusion. A razor is arranged across the linear channel. The razor is recessed in the linear channel. The housing has a longitudinal axis, and the razor is in generally longitudinal alignment with the longitudinal axis of the housing.

The invention also includes a method of cutting a suture during a surgical procedure, comprising the steps of: placing a suture cutting apparatus on a distal end of a gloved finger, the cutter apparatus having a longitudinal axis; advancing the suture cutting apparatus longitudinally towards a suture to be cut; and cutting the suture by a blade arranged in a distalmost end of the suture cutting apparatus. The blade is in general longitudinal alignment with the longitudinal axis of the suture cutting apparatus. The blade in the suture cutting apparatus is preferably recessed in a suture receiving area. The suture receiving area may comprise a V-shaped notch. The suture receiving area may comprise a channel arranged across the distalmost end of the suture cutting apparatus.

### BRIEF DESCRIPTION OF THE DRAWINGS

The objects and advantages of the present invention will become more apparent when viewed in conjunction with the following drawings in which:

FIG. 1A is a side elevational view of a suture cutter apparatus shown disposed on the forefinger of a surgeon's hand;

FIG. 1B is a partial perspective view of the suture cutter apparatus shown in FIG. 1A;

FIG. 1C is an elevational view of the distalmost tip of the suture cutter apparatus;

FIG. 1D is a plan view of the upper side of the suture cutter apparatus;

FIG. 1E is an elevational view of the proximalmost end of the suture cutter apparatus;

FIG. 1F is a plan view of the bottom side of the suture cutter apparatus of the present embodiment;

FIG. 2A is a view similar to FIG. 1A showing a further preferred embodiment of the suture cutter apparatus on the forefinger of a user's hand;

FIG. 2B is an elevational view of the distalmost end of the embodiment shown in FIG. 2A;

FIG. 2C is a plan view of the upperside of the suture cutter apparatus of the present embodiment;

FIG. 2D is an elevation view of the proximal end of the suture cutter apparatus of the present embodiment;

FIG. 2E is a plan view of the lowermost side of the suture cutter apparatus of the present embodiment;

FIG. 3A is a perspective view of a further embodiment of the present invention shown on the little finger of a user's hand;

FIG. 3B is an elevational view of the distalmost end of the suture cutting apparatus shown in the present embodiment;

FIG. 3C is a plan view of the suture cutter apparatus of the present embodiment;

FIG. 3D is an elevational of the proximalmost end of the suture cutter apparatus of the present embodiment; and

FIG. 3E is a plan view of the lowermost side of the housing of the suture cutter apparatus of the present embodiment.

### DETAILED DESCRIPTION OF THE PREFERRED EMBODIMENTS

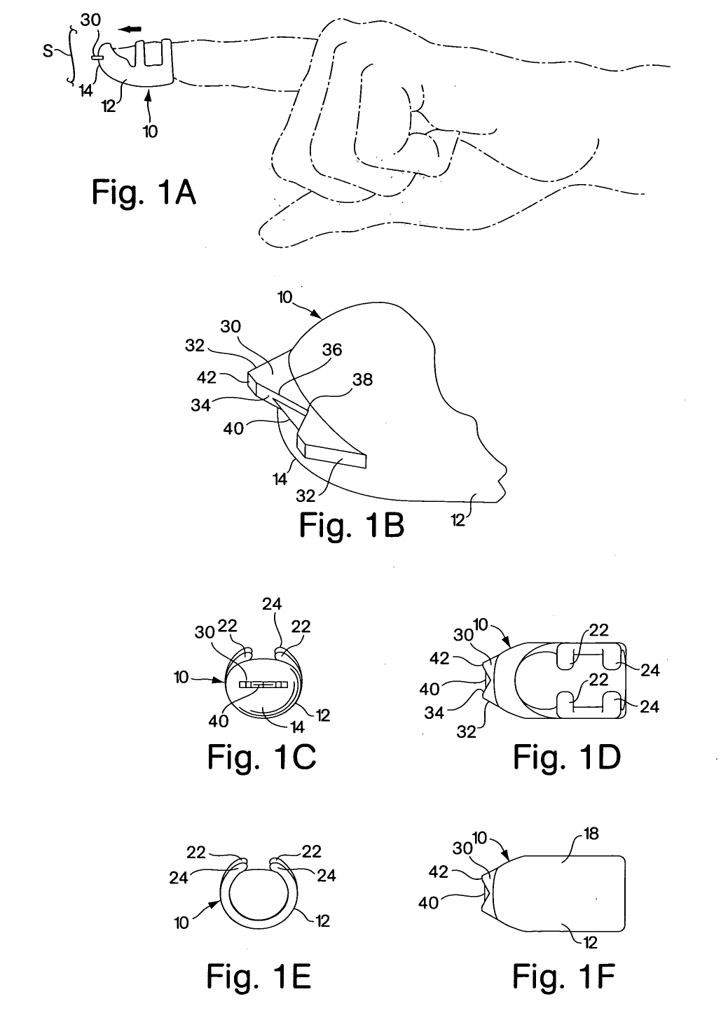

Referring now to the drawings in detail, and particularly to FIGS. 1A and 1B, there is shown the present invention which comprises a fingertip mountable suture cutter apparatus 10 with a housing 12 of generally cylindrical shape. The suture cutter apparatus 10 has a distalmost end 14 of a fingertip-enclosing hemispherical shape and an opened fingertip receiving proximalmost end 16, as represented in figures 1A, 1B and 1E. The housing 12 has an elongated curvilinear lowermost body portion 18, as represented in FIG. 1F, and an uppermost opened portion 20, as represented in FIGS. 1A, 1C, 1D and 1E. The uppermost portion 20 of the housing 12 of the suture cutter apparatus 10 is defined by a first pair and a second pair of slightly flexible, arcuately disposed ribs 22 and 24. The arcuate ribs 22 and 24, a first and second on each lateral side of the housing 12, are spaced longitudinally apart and their tips are spaced transversely apart, as represented in FIGS. 1A and 1D. The spaced-apart configuration of these flexible ribs 22 and 24 permits adaptation of the suture cutter apparatus 10 to any of the fingers of a left or right hand.

A transversely mounted flange 30 is unitarily molded on the distalmost end 14 of the hemispherical tip portion of the housing 12, as best represented in FIG. 1B. The flange 30 has a pair of side edges 32 which taper laterally and proximally towards the hemispherical housing 12. A V-shaped suture receiving notch 34 is arranged across the forward edge of the flange 30, the notch 34 being defined by guide edges 36 meeting at an apex 38 comprising an angle of about 120 degrees. A razor blade 40 is arranged within the V-shaped notch 34 in the flange 30 at the distalmost end 14 of the hemispherical housing 12. The blade 40 is recessed from the distalmost edge 42 of the flange 30 to permit a suture “S” to be guided towards that blade 40 by the sloped guide edges 36 of the V-shaped notch 34 as the user's finger is advanced towards and against a suture “S”, as represented in FIG. 1A. The transverse flange 30 and its recessed blade 40 therewith, generally lie in longitudinal alignment with the longitudinal axis “L” of the user's finger when that finger is arranged within the suture cutting apparatus 10, as represented in FIG. 1B. This longitudinal alignment between the blade 40 and the user's finger permits a natural aiming and a longitudinally directed thrusting motion towards a suture “S” so as to make the cutting thereof a normal part of the finger motion.

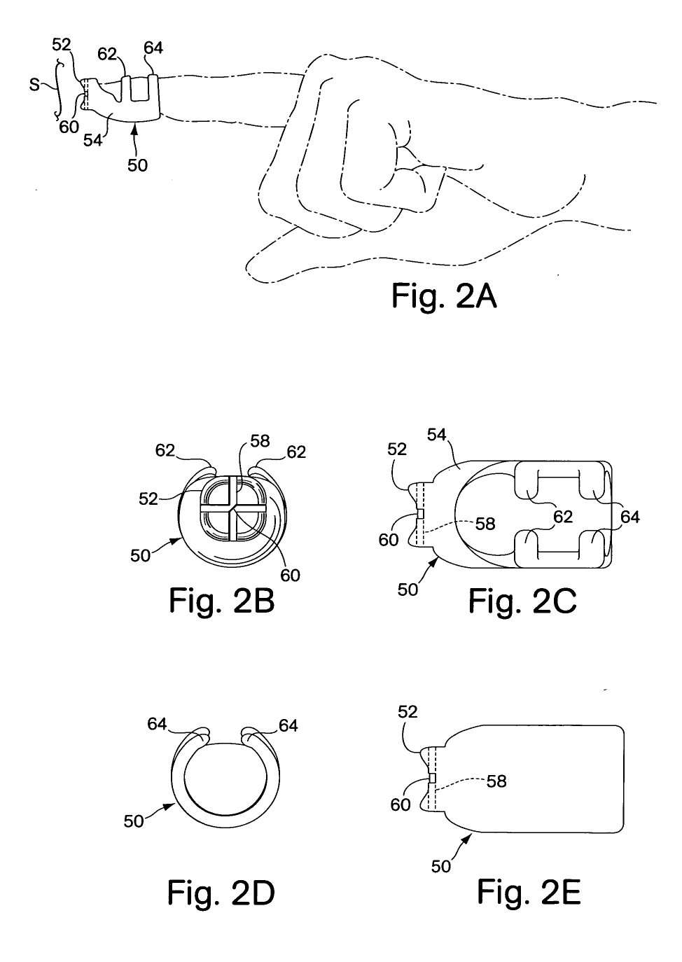

A further embodiment of the present invention comprises a suture cutter apparatus 50 generally similar to the aforementioned embodiment, wherein a generally peripheral flange protrusion 52 extends distally off of the hemispherical tip 54 of the housing 56 of the suture apparatus 50. An X-shaped recess 58, shown in FIG. 2B, is disposed across the peripheral protrusion 52 so as to define the X-shaped recess as a suture receiving channel therewithin. A razor blade 60, shown in FIG. 2B is arranged diagonally across the intersection of the X-shaped receiving channel 58. The X-shaped receiving channel 58 permits a suture to be captured therein by longitudinal advancement of the suture cutter apparatus 50 on a surgeon's fingertip, as represented in FIG. 2A . Such a crossed arrangement of suture receiving channels 58 minimizes the twisting manipulation required of the suture cutting apparatus 50 as it is intended to be used. The suture cutting apparatus 50 includes a pair of opposed spaced apart slightly flexible ribs 62 and 64, as shown in FIGS. 2A, 2B and 2C, as in the aforementioned embodiment.

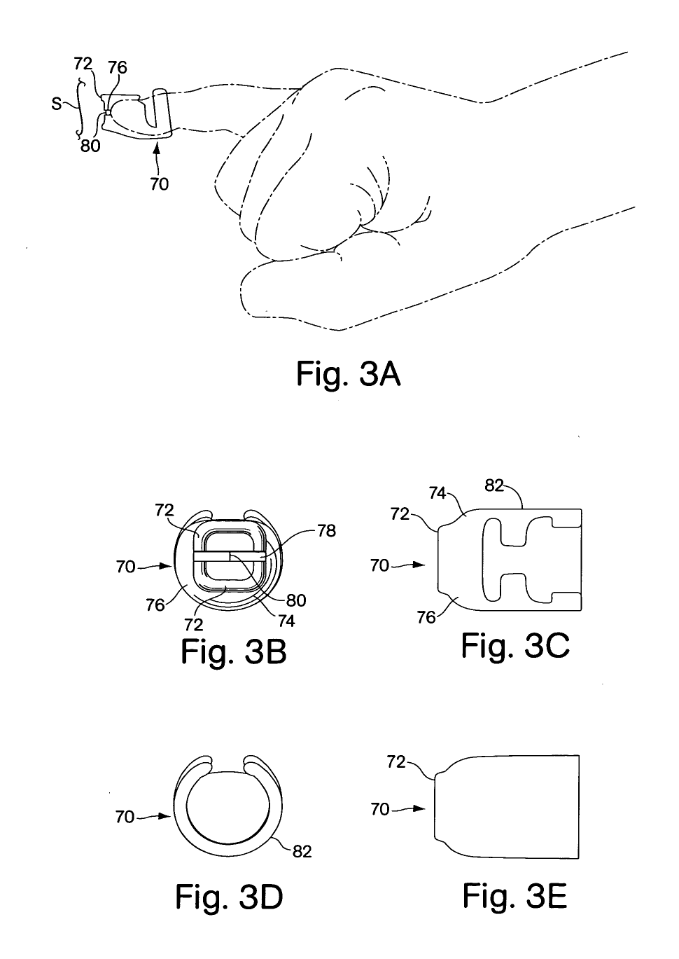

A yet further embodiment of the present suture cutting apparatus 70 is shown in FIG. 3A-3E, generally similar to the aforementioned preferred embodiments, which in this embodiment now however comprises a peripheral protrusion 72 arranged on the distalmost portion 74 of the hemispherical tip 76 of the housing 82 of the suture cutter apparatus 70. A single suture receiving channel 78, shown best in FIG. 3B, is arranged transversely or laterally across the distalmost protrusion 72 to define a suture receiving means. A razor 80 is arranged across that single suture receiving channel 78 and perpendicular thereto, as shown in FIGS. 3A and 3B, and is recessed so as to receive a suture, engaging it so as to cut that suture “S” once it has been received thereacross.

I claim:

1. A suture cutting apparatus for cutting a suture during a surgical procedure, said suture cutting apparatus arranged for receipt on a fingertip, said apparatus comprising:
a hollow, generally cylindrically shaped housing, said housing having a first or distal end and a second or proximal end; and
a razor blade supported on said distal end of said housing.

2. The suture cutting apparatus as recited in claim 1, wherein said first or distal end of said housing is closed by a hemispherically shaped enclosure.

3. The suture cutting apparatus as recited in claim 2, wherein said hemispherically shaped enclosure has a flange on a distal portion thereof to support said blade.

4. The suture cutting apparatus as recited in claim 3, wherein said flange has a V-shaped notch disposed thereon, said blade being arranged in said notch.

5. The suture cutting apparatus as recited in claim 4, wherein said notch has a pair of side edges defining said notch, said notch having an angle of about 120 degrees.

6. The suture cutting apparatus as recited in claim 4, wherein said blade is recessed in said notch.

7. The suture cutting apparatus as recited in claim 1, wherein said proximal end of said housing includes a pair of flexible, laterally spaced apart ribs for circumferential engagement of a finger in said apparatus.

8. The suture cutting apparatus as recited in claim 1, wherein said proximal end of said housing includes a pair of flexible, longitudinally spaced apart ribs for circumferential engagement of a finger in said apparatus.

9. The suture cutting apparatus as recited in claim 1, wherein said proximal end of said housing includes a pair of flexible, laterally and longitudinally spaced apart ribs for circumferential engagement of a finger in said apparatus.

10. The suture cutting apparatus as recited in claim 2, including a peripheral flange protrusion is arranged on said hemispherically shaped enclosure.

11. The suture cutting apparatus as recited in claim 10, including an X-shaped recess arranged across said peripheral protrusion.

12. The suture cutting apparatus as recited in claim 11, wherein a razor blade is arranged diagonally across the intersection of said channels.

13. The suture cutting apparatus as recited in claim 12, wherein said blade is recessed with respect to said channels.

14. The suture cutting apparatus as recited in claim 13, wherein said proximal end of said housing includes a pair of flexible, laterally spaced apart ribs for circumferential engagement of a finger in said apparatus.

15. The suture cutting apparatus as recited in claim 1, wherein said housing has a longitudinal axis, and said blade is in general alignment with said longitudinal axis of said housing.

16. The suture cutting apparatus as recited in claim 10, including a linear channel arranged across said peripheral protrusion.

17. The suture cutting apparatus as recited in claim 16, including a razor arranged across said linear channel.

18. The suture cutting apparatus as recited in claim 17, wherein said razor is recessed in said linear channel.

19. The suture cutting apparatus as recited in claim 17, wherein said housing has a longitudinal axis, and said razor is in generally longitudinal alignment with said longitudinal axis of said housing.

20. A method of cutting a suture during a surgical procedure, comprising the steps of:
placing a suture cutting apparatus on a distal end of a gloved finger, said cutter apparatus having a longitudinal axis;
advancing said suture cutting apparatus longitudinally towards a suture to be cut; and
cutting said suture by a blade arranged in a distalmost end of said suture cutting apparatus.

21. The method as recited in claim 20, wherein said blade is in general longitudinal alignment with said longitudinal axis of said suture cutting apparatus.

22. The method as recited in claim 21, wherein said blade in said suture cutting apparatus is recessed in a suture receiving area.

23. The method as recited in claim 22, wherein said suture receiving area comprises a V-shaped notch.

24. The method as recited in claim 22, wherein said suture receiving area comprises a channel arranged across said distalmost end of said suture cutting apparatus.
